(19) United States
(12) Patent Application Publication
(10) Pub. No.: US 2025/0164033 A1
(43) Pub. Date: May 22, 2025

(54) A CONTROL VALVE DIAGNOSTICS SYSTEM UTILIZING G-FORCE AND VALVE POSITION MEASUREMENT SENSORS INSIDE VALVE POSITIONER

(71) Applicant: KSB MIL CONTROLS LIMITED, Kerala (IN)

(72) Inventor: Lijo Joseph THARAYIL, Kerala (IN)

(21) Appl. No.: 18/842,424

(22) PCT Filed: Feb. 27, 2023
(86) PCT No.: PCT/IB2023/051804

§ 371 Date: Aug. 29, 2024

(30) Foreign Application Priority Data
Mar. 1, 2022 (IN) 202241010920

(51) Int. Cl. F16K 37/00

(52) U.S. Cl. CPC F16K 37/0083

(57) ABSTRACT

The present invention discloses a control valve diagnostics system (100) which comprises of a smart valve positioner (101) having an inbuilt accelerometer (101a), inbuilt non-contact position sensor (101b), an actuator (102), a power source (103), and the non-volatile memory (104). The smart valve positioner (101) is pre-installed with a non-contact position sensor for valve position measurement against maximum ‘g-force’ for a time interval of 5-20 milli seconds. The system (100) captures the ‘g-force’ continuously through inbuilt accelerometer (101a), where the system is powered by 2-wire 4-20 mA loop power or 2-wire fieldbus/profibus (103). The valve position at maximum ‘g-force’ value can be derived by comparing the previous and current ‘g-value’, and the generated data is saved in the non-volatile memory (104).

### TECHNICAL FIELD OF THE INVENTION

The present invention relates generally to valve diagnostics systems and more specifically to a smart positioner for controlling and monitoring the valve operation in a process control system through the ‘g-force’ values, continuously through inbuilt accelerometer.

### BACKGROUND OF THE INVENTION

The valve positioners are devices that adjusts the valve actuator's position based on a control signal. Various types of valve positioners are used in the valve operation control where the positioners are mechanically coupled to an actuator or the positioner is incorporated within the actuator. The actuator provides means for physically positioning the valve, which can be electric, hydraulic or pneumatic.

The most common valve positioners used for valve control are the pneumatic actuators which has a piston or a combination of a spring and diaphragm to position the valve. The valve positioners are coupled to a process control loop over which it gets suitable signal of a valve position desired and operating power for the positioner. The valve positioner controls a pneumatic actuator which in turn controls position of the valve. For this purpose, the smart valve positioners are used which are digital valve controllers based on microprocessors. The smart valve positioners are current to pneumatic instruments with internal logic capability, which are specifically designed to convert a current signal to a pressure signal for valve operation. These valve positioners are best used in control applications because of their precision.

The Patent Application No. EP2972624B1 entitled “Method for valve diagnosis” discloses a method and system to develop a useful lifetime profile for a component of a process control device, such as a valve, and uses that lifetime profile to determine a projected remaining lifetime for the device component in operation. The lifetime profile is developed from using real world operational data of similar process control devices, used under substantially the same operating conditions as to be experienced during operation. Profiles may be developed for numerous device components, from which a projected lifetime profile for the entire process control device is developed. Based on the projected remaining lifetime, notification warnings may be sent to remote computers and maintenance scheduling may be automatically achieved.

The U.S. Pat. No. 9,869,981B2 entitled “Control device diagnostic using accelerometer” where the diagnostic device is physically coupled to a control device in a process control system, and includes an accelerometer that determines when a motion or vibration of the control device is greater than a predetermined threshold. When this condition is detected, one or more other components of the diagnostic device (e.g., processor, communication module, etc.) are activated, and a distress signal is transmitted from the diagnostic device using the activated components. Consequently, the duty cycles of components of the diagnostic device are decreased and optimized, leading to significant power savings. Indeed, in some embodiments, energy harvesting may be sufficient to power the diagnostic device. Further, in some embodiments, the diagnostic device may not require a component processor.

The Patent Application No. US20210120477A1 entitled “Apparatus and method for establishing g maintenance routes within a process control system” where generating a maintenance route in a process control system includes creating an initial ordered list of all wireless nodes in direct communication with a wireless gateway, where the nodes are ordered by signal strength with the wireless gateway device. A subsequent ordered list is created of all nodes in direct communication with first node of the initial ordered list, where the nodes are ordered by signal strength with the first node. The subsequent ordered list is then appended to the initial ordered list after the first node. This process of creating a subsequent list and appending the initial list is iteratively repeated thereafter, each time accounting for the next node in the appended ordered list following the previous iteration until all nodes are accounted for. In the last iteration, the nodes correspond to stop points along the route and the order corresponds to the route to be taken among the stop points.

The U.S. Pat. No. 7,436,797 entitled “Wireless architecture and support for process control systems” discloses a wireless communication system for use in a process environment uses mesh and possibly a combination of mesh and point-to-point communications to produce a wireless communication network that can be easily set up, configured, changed and monitored, thereby making a wireless communication network that is less expensive, and more robust and reliable. The wireless communication system allows virtual communication paths to be established and used within the process control system in a manner that is independent of the manner in which the wireless signals are sent between different wireless transmitting and receiving devices within the process plant, to thereby operate in a manner that is independent of the specific messages or virtual communication paths within the process plant. Still further, communication analysis tools are provided to enable a user or operator to view the operation of the wireless communication network to thereby analyze the ongoing operation of the wireless communications within the wireless communication network.

The U.S. Pat. No. 7,539,560B2 entitled “Control valve and positioner diagnostics” discloses Valve positioning systems may include one or more components and a controller. Components may include one or more electric-to-pressure output converters, relays, gas supplies, and/or actuators. A controller may adjust a position of a valve by sending a signal. The valve positioning system may individually monitor components and determine the condition of each component being individually monitored. The valve positioning system may determine if a component will fail prior to failure and/or determine if a problem will occur in a component prior to the problem occurring.

However, the existing systems does not continuously monitor the sudden movement of valve parts, and the changes in the fluid dynamics flowing through valve and damages to valve internals. Additionally, there are no available systems where the change in valve position corresponding to maximum “g-force” can be monitored, where the g-force values continuously monitored through inbuilt accelerometer. Another drawback of the existing system is that there are no systems for analysis of the trend in logged data of valve position changes corresponding to g-force, and there are no systems which can predict the issues related to valve internals and process fluid parameters which can be used for prevention and diagnosis of the generated issues.

Hence, there exists a need for a system which can detect the changes in fluid dynamics flowing through valve and the damages pertaining to valve internals, thereby enabling prediction of issues related to valve internals and process fluid parameters.

### SUMMARY OF THE INVENTION

The present invention overcomes the drawbacks of the prior art and provides a control valve diagnostics system. The control valve diagnostics system comprises of a smart valve positioner pre-installed with a non-contact position sensor for valve position measurement against maximum ‘g-force’ for predetermined time interval say, each 8 milli seconds. The control valve diagnostics system can capture the ‘g-force’ continuously through inbuilt accelerometer.

According to the present invention, the control valve diagnostics system records the valve position at maximum ‘g-force’ value upon comparison of previous and current “g” or gravitational value. At the time of data logging, the maximum ‘g-force’ value and the corresponding position is written and saved in the non-volatile memory (NVM). Thus, by monitoring the valve position at maximum ‘g-force’, can detect any damages in the valve internals. The ‘g-force’ data which generated is logged and the logged diagnosis data can be downloaded on any electronic device such as smartphone through wired means i.e., USB cable or through wireless means such as BLE.

The present invention involves continuous monitoring of the sudden movement of valve parts, which can control the abrupt changes in the fluid dynamics flowing through valve thereby damaging valve internals. The invention further monitors change in valve position corresponding to maximum g-force and its analysis from logged data to predict issues related to valve internals and process the fluid parameters for prevention and diagnosis of the valve. The updated value can be displayed on LCD of smart valve positioner. The recorded logged data can be used to predict the trend analysis that can predict the issues in the valve control system.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a control valve diagnostics system, according to one embodiment of the present invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The present invention discloses a control valve diagnostics system which comprises of a smart valve positioner pre-installed with a non-contact position sensor for valve position measurement against maximum ‘g-force’ for each a time period of 5-20 milli seconds. The said control valve diagnostics system which can capture the ‘g-force’ continuously through inbuilt accelerometer.

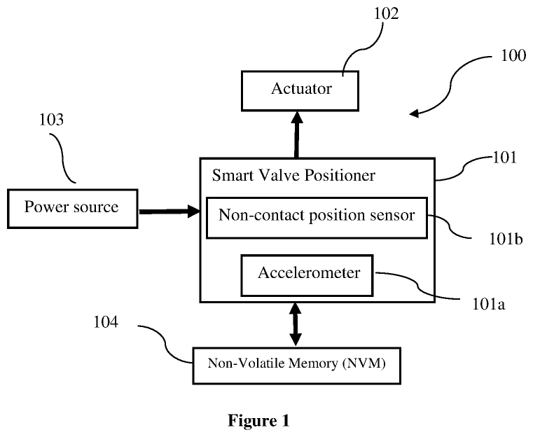

FIG. 1 illustrates a control valve diagnostics system, according to one embodiment of the present invention

The control valve diagnostics system (100) comprises of a smart valve positioner (101) having an inbuilt accelerometer (101a) and non-contact position sensor (101b), an actuator (102), a power source (103), and a non-volatile memory (104). The smart valve positioner (101) is a valve positioner assembly that receives a supply voltage which is representative of the desired valve position. The power source (103) supplies power of 4-20 m Amps or 10-24 volts to the smart valve positioner (101) which has an inbuilt accelerometer (101a) to measure the accelerations or vibrations for different valve opening percentage. The actuator (102) controls the valve which controls the flow in the process and the non-volatile memory allows to save the logged data at selected time intervals.

According to the present invention, the smart valve positioner (101) comprises of an inbuilt accelerometer (101a) which is used to measure the accelerations or vibrations for different valve opening percentage; and non-contact position sensor (101b) which uses a wear-free technology, wherein said sensor contains no friction on the moving parts which eliminates wear and tear and mechanical failure. The said non-contact position sensor (101b) that can measure movement or displacement.

The valve opening percentage may directly relate to flow through valve or inversely proportional to pressure drop across inlet and outlet of valve. The inbuilt accelerometer (101a) measures the accelerations from inside the smart valve positioner (101) which is mounted on the actuator (102). The actuator (102) provides pressure and position feedback to said smart valve positioner (101)

The Non-volatile memory (104) disclosed in the present invention can be EEPROM/Flash/PRAM/FRAM/MRAM which is located inside the microprocessor. The non-volatile memory (104) enables saving the logged data i.e., the maximum g-force value corresponding to the valve position at selectable time intervals. The valve position at maximum ‘g-force’ value is derived by comparing the previous and current ‘g’ or gravitational values. The logged data is saved in the non-volatile memory (104), where the logged data can be used to monitor the valve position at maximum ‘g-force’, through which any damages in the valve internals can be detected.

According to the present invention, the process of operation of the smart valve positioner (101) includes powering the smart valve positioner (101) which is powered by 2 wire 4-20 mA loop power or 2 wire fieldbus/profibus, which is representative of the desired valve position. The smart valve positioner (101) when supplied with power supply, provides a pneumatic output to the actuator (102). The actuator (102) controls the valve which controls the fluid flow and further provides pressure and position feedback to the smart valve positioner (101). The accelerometer (101a) which is located inside the smart valve positioner (101) measures the accelerations or vibrations for different valve opening percentage. The accelerations which are measured, are saved in a non-volatile memory (104) which stores the data in the microprocessor, which includes on-chip program and storage memory (EEPROM/Flash/PRAM/FRAM/MRAM).

The electrically erasable programmable read-only memory (EEPROM) uses voltage to erase memory. The data is stored by use of floating gate transistors which require special operating voltages to trap or release electric charge on an insulated control gate to store information. The non-volatile memory (104) allows to save the logged data at regular intervals which can be selected by the users.

The present invention involves continuous monitoring of the sudden movement of valve parts, which can control the abrupt changes in the fluid dynamics flowing through valve and damages to valve internals. The control valve diagnostics system (100) further monitors change in valve position corresponding to maximum g-force and its analysis from logged data to predict of issues related to valve internals and process the fluid parameters for prevention and diagnosis of the valve. The updated value can be displayed on LCD of smart valve positioner.

According to the present invention, the ‘g-force’ data which is generated by the system is logged and the logged diagnosis data can be downloaded on any electronic device like smartphone through wired means i.e., USB cable or through wireless means such as BLE. The smart valve positioner (101) can capture the ‘g-force’ data through the inbuilt accelerometer (101a) continuously where the valve position at maximum ‘g-force’ value is recorded. At the time of logging the maximum ‘g-force’ value and the corresponding valve position will be saved in the said non-volatile memory (104).

The smart valve positioner (101) is powered by 2 wire 4-20 mA loop power or 2 wire fieldbus/profibus (103). The smart valve positioner (101) receives its power from the 4-20 mA power source (103), which supplies current to the system which is same throughout the 4-20 mA loop, hence the voltage drops caused by loop-powered smart valve positioner (101) do not affect the current signal. Additionally, the advantage of using the loop-power is that it would not require any separate or independent power source. The 2 wire 4-20 mA loop power or 2 wire fieldbus/profibus is designed to use the power from the current flowing in the loop. The smart valve positioner (101) can support wired or wireless interface for transferring logged data including g-force values within available loop power, which do not have any dependency on external power.

There are several advantages of the present invention, which includes: the system is powered by 2 wire 4-20 mA loop power or 2 wire fieldbus/profibus which makes the system self-sufficient, and doesn't depend on external power source. Another advantage of the present invention is that the system can monitor the sudden movement of the valve parts through the ‘g-force’ values captured by the inbuilt accelerometer. Another advantage of the present invention is that the valve position measurement can be achieved using non-contact positioner sensor located inside the smart valve positioner. Yet another advantage of the present invention is that the system enables downloading the diagnosis data through both wired and wireless technologies.

1. A control valve diagnostics system (100) for valve position measurement against maximum ‘g-force’, wherein the system comprises:
a. a smart valve positioner (101) pre-installed with an accelerometer (101a) and a non-contact position sensor (101b);
b. an actuator (102) to control the valve;
c. a power source (103) to supply power to the control valve diagnostics system (100); and
d. a non-volatile memory (104) which stores the data in a microprocessor;
wherein the control valve diagnostics system (100) enables valve position measurement against maximum ‘g-force’ for a time range of 5-20 milli seconds, where said system captures the ‘g-force’ continuously through inbuilt accelerometer (101a).

2. The system as claimed in claim 1 wherein the smart valve positioner (101) has an inbuilt accelerometer (101a) which measures the accelerations or vibrations for different valve opening percentage.

3. The system as claimed in claim 1 wherein the non-volatile memory (104) is EEPROM/Flash/PRAM/FRAM/MRAM which is located inside the microprocessor.

4. The system as claimed in claim 1 wherein the power source (103) is a 2 wire 4-20 mA loop power or a 2-wire fieldbus/profibus (103), wherein the power source (103) enables the system to be self-sufficient as its independent of any external power source.

5. The system as claimed in claim 1 wherein the non-volatile memory (104) enables saving the logged data to monitor the valve position at maximum ‘g-force’, through which any damages in the valve internals is detected.

6. A method of operation of a control valve diagnostics system (100) comprises the steps of:
a. powering a smart valve positioner (101) by supplying power from a power source (103);
b. providing a pneumatic output to an actuator (102) where said actuator (102) controls a valve which controls a fluid flow and further provides pressure and position feedback to said smart valve positioner (101);
c. measuring accelerations or vibrations for different valve opening percentage by accelerometer (101a) which is located inside the smart valve positioner (101);
d. saving the measurement data in a non-volatile memory (104) which stores the data in a microprocessor, which includes on-chip program and storage memory (EEPROM/Flash/PRAM/FRAM/MRAM); and
e. monitoring a change in valve position corresponding to maximum ‘g-force’ and its analysis from logged data to predict of issues related to valve internals and process the fluid parameters for valve diagnosis.

7. The method as claimed in claim 6 wherein the ‘g-force’ data generated by the system is logged and the logged diagnosis data can be downloaded on any electronic device through wired means or through wireless means.

8. The system of claim 3, wherein the non-volatile memory comprises EEPROM.

9. The system of claim 3, wherein the non-volatile memory comprises Flash.

10. The system of claim 3, wherein the non-volatile memory comprises PRAM.

11. The system of claim 3, wherein the non-volatile memory comprises FRAM.

12. The system of claim 3, wherein the non-volatile memory comprises MRAM.

13. The system of claim 4, wherein the power source comprises a 2 wire 4-20 mA loop power.

14. The system of claim 4, wherein the power source comprises a a 2-wire fieldbus/profibus.

15. The method of claim 7, wherein the electronic device comprises a smartphone.

16. The method of claim 7, wherein the logged diagnosis data can be downloaded through wired means.

17. The method of claim 16, wherein the wired means comprises a USB cable.

18. The method of claim 7, wherein the logged diagnosis data can be downloaded through wireless means.

19. The method of claim 18, wherein the wireless means comprises BLE.
